(19) United States
(12) Patent Application Publication
(10) Pub. No.: US 2003/0233923 A1
(43) Pub. Date: Dec. 25, 2003

(54) Woodworking drill

(76) Inventor: Eu-Pin Wang, Shindian City (TW)

Correspondence Address: TROXELL LAW OFFICE PLIC, Suite 1404, 5205 Leesburg Pike, Falls Church, VA, 22041, US

(21) Appl. No.: 10/175,035

(22) Filed: Jun. 20, 2002

(51) Int. Cl. B25B 21/00; B23B 51/00; B26D 1/12

(52) U.S. Cl. 83/669; 30/500

(57) ABSTRACT

A woodworking drill includes a slab-shaped blade and a blade handle connected behind a body of the blade. The top of the blade is shaped as a point of blade with shoulders on both sides of the point of blade. On the edge of the point of blade, the shoulder cutting faces and the blade that contact with the working object set the cutting guiding angles. A bending mechanism in the same direction of the drill's rotation is designed on both shoulder cutting faces. This design reduces contacting resistance or cutting resistance between bended shoulder cutting faces and working objects and enhances efficiency of clearing out saw dust. With the bended shoulder cutting faces, the drill can clear out saw dust more effectively, enhance cutting speed and working performance as well as prevent the abrasion to the drill.

### BACKGROUND OF THE INVENTION

1. Field of the Invention

The present invention is a woodworking drill, especially the woodworking drill with bended angles on the shoulder cutting faces designed for reducing cutting resistance generated by drilling, improving cutting speed and clearing out the saw dust during drilling, which in turn enhances working performance and reduces the abrasion to the drill.

2. Description of the Prior Art

Please refer to FIG. 1 for the traditional woodworking drill that consists of a slab-shaped blade 1 connected by a blade handle 2. A point of blade 11 protrudes on the top of the blade 1. Smooth cutting faces 12 are affixed on both shoulders of the point of blade 11. The drill of the prior art pierces and positions with the point of blade 11 focusing on the target. Then, with the shoulder cutting face 12 to cut by large areas, the required holes take shape.

To enable the drilling to proceed smoothly, drills of the prior art are installed with the cutting angles on the edge of the blade 1, the point of blade 11 and the shoulder cutting face 12. During the drilling of the blade, the saw dust can be cleared out from the space formed by the cutting angles, avoids the saw dust to block the drilling path, enhances working efficiency and levels down the abrasion to the blade.

However, according to the inventor's practical experience, the soft textual and easy-to-break characteristic of the wood cause lots of saw dust quickly during the drilling operation. Therefore, being unable to clear out the too much saw dust in time by the cutting angles hinders the drilling path and influences the working performance. One woodworking drill clears out the saw dust in an airstream method by leveling the jet tube at the working area. When saw dust occurs during drilling, the dust is cleared out by being jetted with air to avoid the saw dust from clogging the drilling path. Nevertheless, the efficacy of such drills is limited. Moreover, one must prepare an air compressor separately to use such drills, which in turn increases the cost. As for the situation where the depth of the drill is quite deep, the jet tube fails to approach the working are of the drill and then the obstruction caused by the saw dust might still occur.

In view of this, drills of the prior art still have lots of disadvantages and then have much for improvement.

### SUMMARY OF THE INVENTION

The objective of the present invention is to provide a type of woodworking drill that reduces the cutting resistance while clears out a great deal of saw dust generated during the drilling, which in turn enhances working efficiency and cutting speed.

The foregoing woodworking drill that can achieve the objectives of the invention consists of the slab-shaped blade with the blade handle connected behind. On top of the body of the blade is the point of blade with the shoulder cutting faces on both sides of the point of blade. The cutting angles are designed on the edge of the point of blade, the shoulder cutting faces and the blade that contact with the object. The shoulder cutting faces on both sides of the blade can be bended which reduces the resistance during contacting with the object. During the drilling of the blade, the saw dust generated from drilling is cleared out through the space of the cutting angles. Furthermore, the reduction in cutting resistance enhances cutting speed and working efficiency and diminishes the abrasion to the drill.

### BRIEF DESCRIPTION OF THE DRAWINGS

The drawings disclose an illustrative embodiment of the present invention which serves to exemplify the various advantages and objects hereof, and are as follows:

FIG. 1 is a three-dimensional illustration of the traditional woodworking drill;

FIG. 2 is a three-dimensional illustration of the woodworking drill for the present invention;

FIG. 3 is a front-view illustration for the present invention;

FIG. 4 is a lateral-view illustration for the present invention

FIG. 5 is a crane-view illustration for the present invention

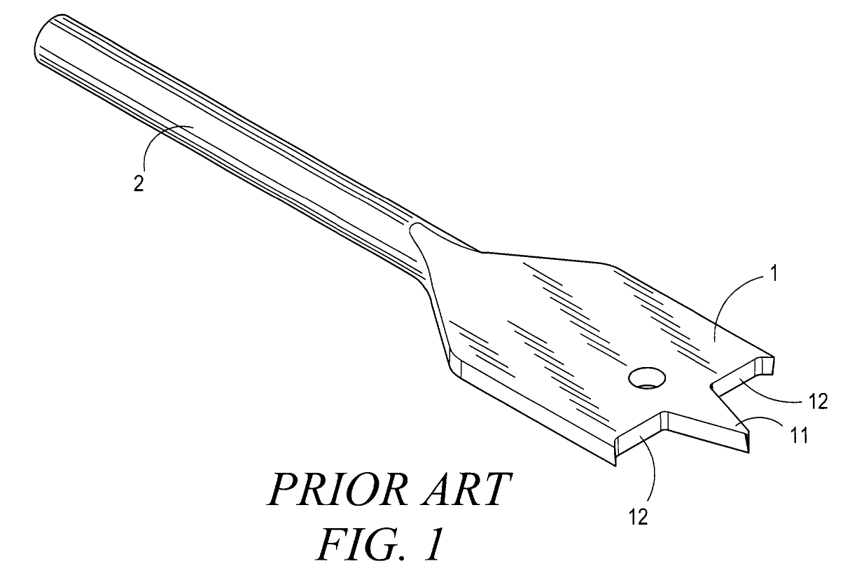

### DETAILED DESCRIPTION OF THE PREFERRED EMBODIMENT

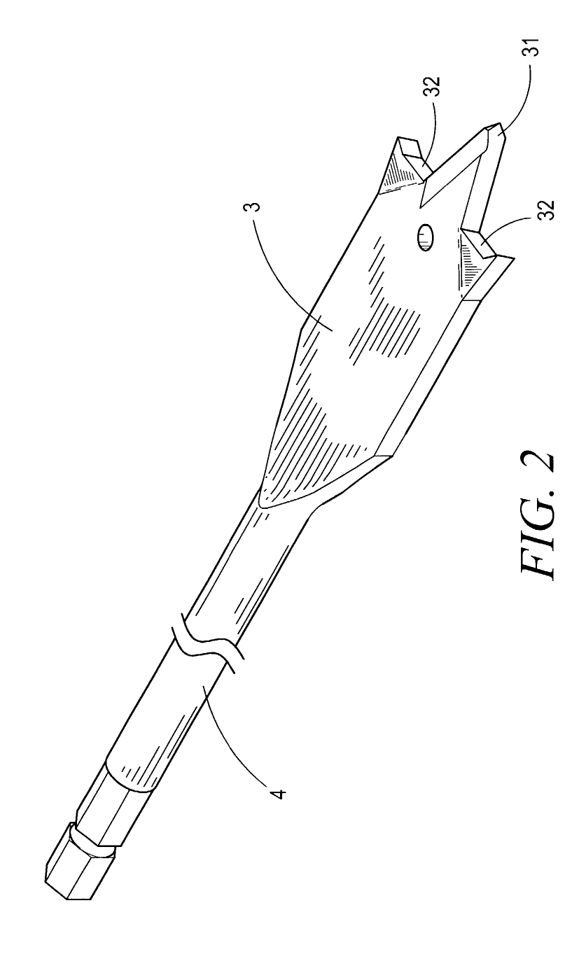

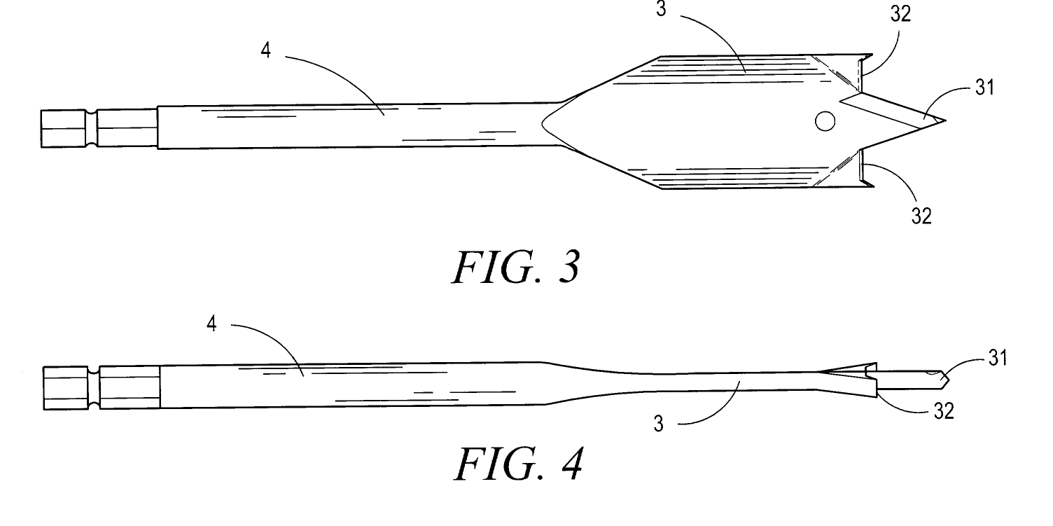

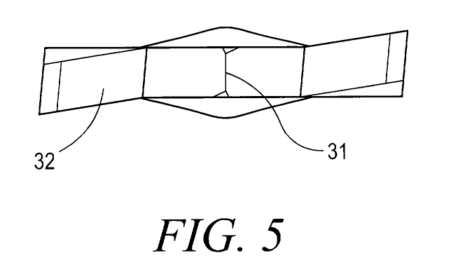

Please refer to FIGS. 2 to 5. The woodworking drill of the present invention includes the slab-shaped blade 3 with the blade handle 4 connected behind that drives the blade 3 to rotate and work. In the front of the blade 3 is the point of blade 31 with the shoulder cutting faces 32 on both sides of the point of blade 31. The point of blade 31 aims at drilling and positioning by focusing itself on the central point of the drilling path, while guiding the blade 3 behind to keep on drilling. The shoulder cutting faces 32 beside the point of blade 3 are designed for the large-scale cutting to the drilling path, so as to produce the required cutting path for the hole. Then, the cutting guiding angles are installed on the edges of the forgoing point of blade 31, the shoulder cutting face 32 and the blade 3 that contact with the object, in order to clear out the saw dust caused by the drilling through the gap of the cutting guiding angles and prevent it from choking up the drilling path.

The primary design for the present invention is to bend the shoulder cutting faces 32 on both sides of the top of the blade 3 in the direction of the drill's rotation, which lessens the contacting resistance or cutting resistance between the folded shoulder cutting faces 32 and the object, and then enhances the efficiency of the drill and the cutting speed as well as clear out a great deal of saw dust during drilling and keep it from blocking the drilling path.

The woodworking drill for the present invention designed with the shoulder cutting faces not only decreases the contacting resistance or cutting resistance, promotes the efficiency of the drill and cutting speed, but also clears out the saw dust caused by drilling more effectively to avert it from blocking the drilling path, which advances the working efficiency and avoids the abrasion to the drill. The improvement degree of the cutting states as Table 1. Because the drilling speed increases and the saw dust is kept from blocking the drilling path, the accuracy and smoothness of the drilling hole's diameter are maintained.

Table 1 is the comparison of the cutting function between the present invention and the traditional woodworking drill. The drilling test involves drilling with the woodworking drill on the planks in same size and thickness and with fixed force and then compared the cutting speed of the present invention with the traditional woodworking drill, which indicated the improvement level of the cutting speed by the present invention. As shown in Table 1, the present invention significantly enhances the efficiency and cutting speed. In spite of the various improvement level for different sizes of the woodworking drill, the improvement in cutting speed by the present invention is as clear as day.

TABLE 1

| The | | | | Drilling | |
|---|---|---|---|---|---|
| diameter of | Drill | Plank | Drilling | speed | Improvement |
| the drill | type | thickness | time | cm/sec | level |
| ¾ inches | Traditional | 4.1 cm | 5 sec. | 0.82 | |
| | drills | | | | |
| | The present | 4.1 cm | 2.7 sec. | 1.5 | 83% |
| | invention | | | | |
| 1 inches | Traditional | 4.1 cm | 5.8 sec. | 0.71 | |
| | drills | | | | |
| | The present | 4.1 cm | 4.3 sec. | 0.95 | 34% |
| | invention | | | | |

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A woodworking drill, comprising a slab-shaped blade and a blade handle connected behind a body of said blade, a point of blade shaped on top of said blade, on both sides of said point of blade fitted shoulders, on an edge of said point of blade, said shoulder cutting faces and said blade that contacts with an working object set a cutting guiding angles, characterizes in that:
a bending mechanism is designed on both shoulder cutting faces on top of said blade in a same direction of a drill, such design reduces contacting resistance or cutting resistance between a bended shoulder cutting faces and a working object, thus increases cutting speed as well as clears out saw dust more effectively.
